(19) United States
(12) Patent Application Publication
(10) Pub. No.: US 2009/0211612 A1
(43) Pub. Date: Aug. 27, 2009

(54) Super-thin water jetting lance

(76) Inventors: Christos Athanassiu, Winchester, MA (US); Joseph William Valentine, JR., Franklin, MA (US); Michael W. Osborne, Clinton, MA (US); Abed Kanaan, Harvard, MA (US)

Correspondence Address: Iandiorio Teska & Coleman, 260 Bear Hill Road, Waltham, MA, 02451-1018, US

(21) Appl. No.: 12/315,295

(22) Filed: Dec. 2, 2008

Related U.S. Application Data
(60) Provisional application No. 61/010,340, filed on Jan. 8, 2008.

(51) Int. Cl. B08B 3/02

(52) U.S. Cl. 134/54; 134/167 C; 134/60

(57) ABSTRACT

A steam generator lance configured as a stack of adjacent tubes in a single column. The tubes are secured at least some locations. The lance includes a distal end with tube nozzles. A mechanism is provided for positioning the distal end of the lance into a tube lane. There is typically another mechanism for driving the lance so that the distal end thereof enters the tube lane.

### RELATED APPLICATIONS

This application hereby claims the benefit of and priority to U.S. Provisional Application Ser. No. 61/010,340, filed on Jan. 8, 2008 under 35 U.S.C. §§119, 120, 363, 365, and 37 C.F.R. §1.55 and §1.78.

### FIELD OF THE INVENTION

The subject invention relates to cleaning and inspection systems used within steam generators.

### BACKGROUND OF THE INVENTION

Steam generators convert heat from the primary side of a pressurized water reactor type nuclear power plant to steam on the secondary side so that the primary and secondary systems are kept separate. A typical generator is a vertical cylinder consisting of a larger number of U-shaped tubes which extend from the floor or “tube sheet” of the generator upwards. High temperature and pressure fluid from the reactor travels through the tubes giving up energy to a feed water blanket surrounding the tubes in the generator creating steam and ultimately power when later introduced to turbines.

Steam generators were designed to last upwards of forty years but in practice such reliability figures have proven not to be the case. The problem is that sludge from particulate impurities suspended in the feed-water forms on the tubes which greatly affects the efficiency of the generator and can even cause the tubes to degrade to the point of causing fissures in the tubes. If radioactive primary fluid within the tubes seeps into the secondary side, the result can be disastrous. Plugging or otherwise servicing such fissures is time consuming and results in expensive down time during which power must be purchased from other sources at a great expense.

There are known methods for cleaning the tubes. Chemical cleaning is very expensive (from $5,000,000 to $10,000,000 per application) and requires an extended outage. Also, some corrosion of steam generator internals by the solvents used will occur during the cleaning. In addition, large quantities of hazardous, possibly radioactive waste may be generated. Disposal of this waste is very expensive. For these reasons, few plants have actually implemented chemical cleaning. Alternative cleaning methods, such as inter-tube high pressure water system s can be advantageous.

On the other hand, there are severe technical challenges faced when considering such alternate cleaning methods. One typical steam generator has approximately 50,000 square fee of heat transfer area. The typical tube bundle is about 10 feet in diameter and 30 feet tall but the no tube lane in the middle of the tube bundle varies. In some models, the alley is more than four inches wide; in others it is as small as one inch. Access into steam generator internals is as much as eight inch diameter holes to as little as two inches. Finally, inter-tube gaps range from about 0.4 inches to about 0.11 inches wide.

U.S. Pat. No. 5,036,871, incorporated herein by this reference, discloses a system for cleaning tubes in such a steam generator. A transporter advances along the blow down lane in the steam generator between the tubes. A flexible lance extends outwardly at 90 degrees from the transporter and is able to maneuver between the tubes to clean and/or inspect them. See also U.S. Pat. Nos. 7,086,353; 6,820,575; RE 38,542; 6,543,392; 5,913,320; 5,695,003; and 4,456,068 all incorporated herein by this reference.

The system disclosed in U.S. Pat. No. 5,036,871, is typical of existing technology, and serves well steam generators with lange lanes (greater than 2.5 inches) and inter-tube gaps greater than 0.15 inches.

In some steam generators, however, such as the model CE-80 design, the blow down lane or “no-tube lane” along the tube sheet is very restrictive because a thick divider plate splits the hand hole opening, providing limited access (less than 1.35 inches) on either side and the inter-tube gap may not exceed 0.116 inches.

A typical flexible lance transporter is too large to enter such a blow down or no-tube lane in these steam generators and conventional lances are too thick to enter the small tube gaps and do any meaningful work.

Any device or system introduced into a steam generator must be highly reliable given the high cost of the steam generator.

### BRIEF SUMMARY OF THE INVENTION

It is therefore an object of this invention to provide a new cleaning and/or inspection lance.

It is a further object of this invention to provide a super-thin water jetting lance which makes it possible to access steam generator inter-tube gaps that conventional and commercially available lances cannot access because of geometrical limitations.

It is a further object of this invention to provide such a cleaning/inspection lance which is reliable, easy to operate, and efficient.

It is a further object of this invention to provide a steam generator cleaning system which maximizes hydraulic pressure for more effective cleaning.

It is a further object of this invention to provide such a system with fewer components for increased reliability.

The subject invention results from the realization that a new steam generator cleaning system lance able to proceed within a tube lane as narrow as 0.116 inches includes a stack of adjacent tubes secured together at least some locations wherein the tubes have a diameter less than the width of the tube lane and there is no lance structure wider than the tube lane or even the tubes themselves and deliver hydraulic cleaning power equal to that of conventional systems. An inspection lance, configured similarly to the cleaning lance, is also provided. Mechanisms are provided to drive and orient both lances. A bulk cleaning head is also provided to clean the steam generator from the no-tube lane.

The subject invention features a steam generator cleaning system comprising a cleaning lance comprising a stack of adjacent tubes in a single column. The tubes are secured together at least some locations. The lance includes a distal end with tube nozzles. A mechanism is provided for positioning the distal end of the lance in a no-tube lane of the steam generator at the entrance to a tube lane and for guiding the distal end of the lance into said tube lane. There are typically means for driving the lance so that the distal end thereof enters said tube lane.

In one example, the lance includes a thin drive strip on the top and bottom of the tube stack. Each drive strip may include spaced drive sprocket holes. The means for driving may then include an upper sprocket and a lower sprocket and a motor for rotating the upper and lower sprockets. Preferably the drive strip is made of a metal thinner than the diameter of the tubes. The tubes are preferably made of metal and are typically brazed together at least some locations.

In one embodiment, a sliding lance guide is received in a no-tube lane. The preferred sliding lance guide transporter includes rollers configured to reorient the lance at an angle for insertion into a tube lane. A rail is received in the no-tube lane and slidingly supporting the sliding lance guide. An inflatable bladder biases the rail against a steam generator divider plate in the no-tube lane. In this way, the sliding lance guide includes a lance guide break operable to engage the lance so the means for driving, when operated with the break engaging the lance, drives the sliding lance guide and the means for driving, when operating with the break disengaged, drives the lance. In one version, the sliding lance guide includes a lance guide tape extending therefore and further including a tape break, which, when operated to engage the tape, and with the lance break disengaged from the lance, fixes the sliding lance guide in a particular position so that the means for driving operates to drive the lance into a tube lane.

In one design, the tube nozzles comprise reduced diameter tubes. In another design, the tube nozzles comprise reduced diameter tube sections. In still another design, the tube nozzles comprise jet nozzles attached to the tubes. In another design, the tube nozzles include a lance head plenum.

There are typically N tubes, M of which carry a cleaning fluid, M/2 of which are angled upwardly at the distal end of the lance, and M/2 of which are angled downwardly at the distal end of the lance. M is usually less than N so select tubes can be used for inspection and the like. In one example, the system includes a high pressure cleaning fluid supply connected to a proximal end of the lance, a manifold for the upwardly angled tubes, and a manifold for the downwardly angled tubes. There may be means for sensing a differential pressure between both manifolds and processing electronics responsive to the means for sensing a differential pressure and configured to stop the supply of cleaning fluid to the tubes if a differential pressure greater than a preset threshold exists in the manifolds to prevent potential damage to the lance and/or steam generator. In the prototype design, the outer diameter of each tube was small and the maximum width of the lance was less than 0.086 inches. The system may further include an inspection lance configured with tubes secured together at least some locations.

The subject invention also features a steam generator cleaning system comprising a cleaning lance comprising a stack of adjacent tubes in a single column. The tubes are secured together at least some locations. The lance includes a distal end with tube nozzles. There are N tubes, M of which carry a cleaning fluid, M/2 of which are angled upwardly at the distal end of the lance, and M/2 of which are angled downwardly at the distal end of the lance. A mechanism is provided for positioning the distal end of the lance in a no-tube lane of the steam generator at the entrance to a tube lane and for guiding the distal end of the lance into said tube lane. There are means for driving the lance so that the distal end thereof enters said tube lane. A high pressure cleaning fluid supply is connected to a proximal end of the lance. There is a manifold for the upwardly angled tubes and a manifold for the downwardly angled tubes. There are means for sensing a differential pressure between both manifolds and processing electronics responsive to the means for sensing a differential pressure configured to stop the supply of cleaning fluid to the tubes if a differential pressure greater than a preset threshold exists in the manifolds to prevent potential damage to the lance and/or steam generator.

One steam generator lance in accordance with the subject invention includes a cleaning lance comprising a stack of adjacent tubes in a single column. The tubes secured together at least some locations. The lance includes a distal end with tube nozzles. A thin drive strip is secured on both the top and bottom of the tube stack.

A small tube gap steam generator can be cleaned and inspected via a stack of adjacent metallic tubes in a single column, the tubes secured together at least some locations; the tubes having a diameter less than the width of the tube lane; and no lance structure wider than the tube lane.

The subject invention also features a steam generator tube lane cleaning and/or inspection lance configured as a stack of adjacent metallic tubes in a single column secured together at least some locations, a thin drive strip on both the top and bottom of the tube stack, wherein the tubes have a diameter less than the width of the tube lane and no lance structure wider than the tube lane.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional view showing a cleaning lance/transport subsystem in accordance with U.S. Pat. No. 5,036,871;

FIG. 2 is a schematic side view of an example of a super-thin water jetting lance in accordance with the subject invention;

FIG. 3 is a is a schematic top cross-sectional view of a typical CE-80 steam generator being cleaned by steam generating cleaning system in accordance with the subject invention;

FIG. 4 is a is a cross-sectional view taken along lines 4-4 of FIG. 3;

FIG. 5 is a highly schematic top-view of a sliding lance guide used to position and guide the lance within a steam generator in accordance with the subject invention;

FIG. 6 is a schematic view showing the deployment of a super-thin lance through a steam generator hand hole in accordance with the subject invention;

FIG. 7 is a more detailed drawing showing the deployment of a lance through a steam generator hand hole;

FIG. 8 is a schematic diagram showing the primary components associated with a balanced protection subsystem in accordance with an example of the subject invention;

FIG. 9 is a schematic partial side-view of another version of a lance in accordance with the subject invention;

FIG. 10 is a is a schematic partial side-view of still another example of a super-thin water jetting lance head in accordance with the subject invention;

FIG. 11 is a schematic partial side-view of still another example of a super-thin water jetting lance head in accordance with the subject invention;

FIG. 12 is a schematic side-view of a super-thin tube sheet inspection lance in accordance with the subject invention; and

FIG. 13 is a schematic view showing one example of a lance driver in accordance with the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

A super-thin water jetting lance in accordance with the subject invention makes it possible to access steam generator inter-tube gaps where conventional or other commercially available lances cannot access because of geometrical limitations.

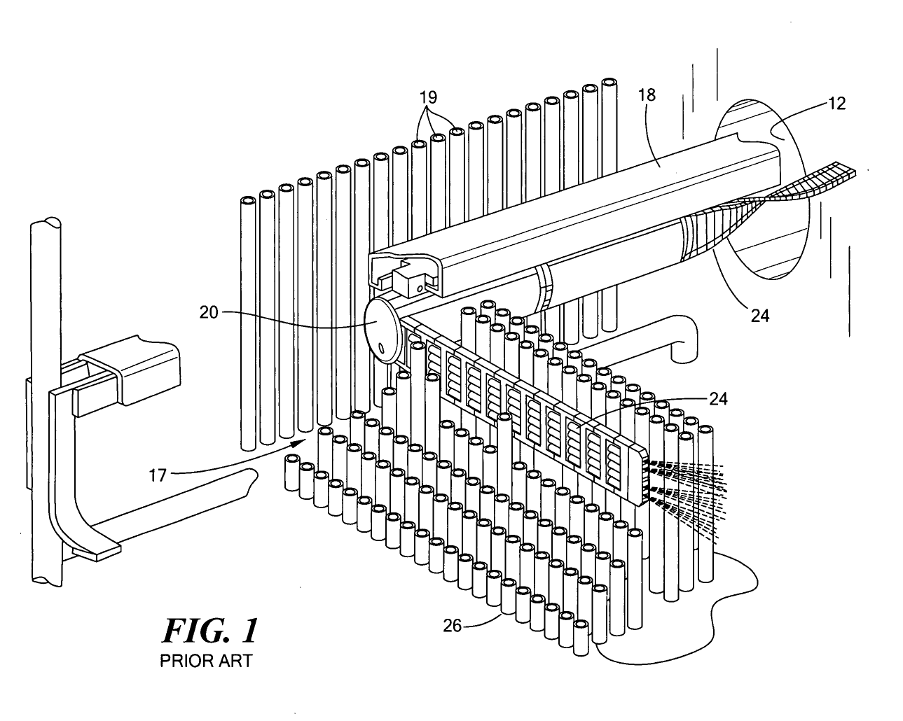

Commercially available equipment was designed to access steam generator inter-tube gaps by introducing a robotic device in the steam generator no-tube lane. FIG. 1 shows the hand hole 12 leading to the interior of a steam generator with tubes 19 on either side of no-tube lane 17. Robotic device 20, positioned in no-tube lane 17, rides on rail 18 and deploys flexible lance 24 in the tube lanes for inspection and sludge deposit cleaning. The existing lance comprises a number of high pressure hoses, means to visually inspect the inter-tube gaps, an exoskeleton in the form of discrete vertebrae or plastic/metallic sheathing, and means to deliver high pressure water jets. See U.S. Pat. No. 5,036,871 incorporated herein by this reference.

One problem with this existing technology is that lance 24 is too thick to enter the small tube gaps of a CE-80 steam generator and deliver meaningful hydraulic power necessary for removal of hard sludge deposits. In the existing technology, the lance body structure necessary for driving the lance into steam generator tube lanes is provided by its exoskeleton, and as a result, the hydraulic hoses, typically plastic hose encased in metallic weave material, further limit the hose internal diameter and, as a result, the amount of water (hydraulic power) that it can deliver. In addition, the type CE-80 steam generator no-tube lane geometry is such that none of the commercially available equipment can enter the no-tube lane and deliver a lance. The tube lanes are typically only 0.116 inches wide.

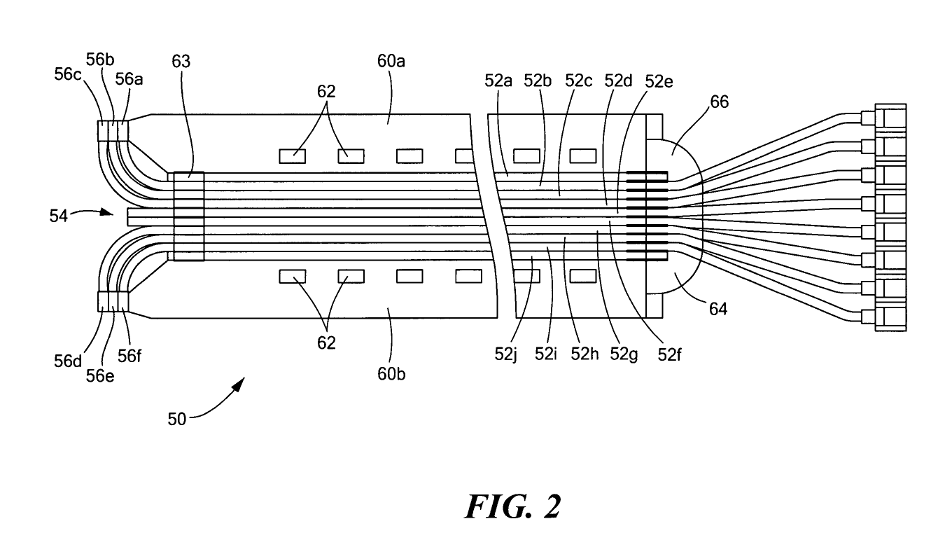

In one example of the subject invention, cleaning lance 50, FIG. 2 includes a stack of adjacent metallic tubes 52a-52j in a single column and secured together by brazing at periodic intervals as shown at 63. Distal end 54 includes tube nozzles 56a-c and 56d-f, in this example, water jet nozzles mechanically attached to the ends of tubes 52b-d and 52g-i respectively. In this specific design, tubes 52a and 52j are “buffer” tubes used for support only and thus they carry no cleaning fluid. Tubes 52e and 52f are used for air purging, light, fiber optics, and the like and also carry no cleaning fluid.

Tubes 56a-c are angled upwardly and tubes 56h-j are angled downwardly at the distal end 54 of the lance for a complete and balanced lance behavior. The downward tubs 56h-j impinge and clean the tube sheet, while tubes 56a-c provide counter balance. In this particular embodiment, the outer diameter of each tube is less than 0.116 inches and indeed the total width of lance 50 is typically less than 0.086 inches.

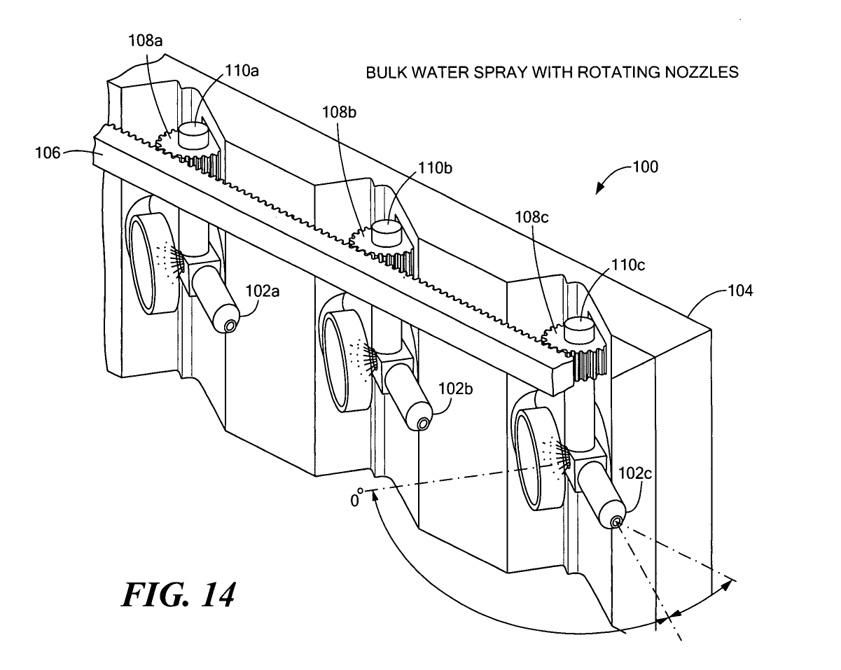

Thin metallic upper 60a and lower 60b lance drive strips are brazed/welded to tubes 52a and 52j, respectively, in this particular example. These strips, less than 0.086 inches in width and typically less than half the thickness of the tubes themselves, may include spaced-drive sprocket holes 62 as shown for engagement by a device which drives the lance. One such lance drive is discussed below in relation to FIG. 13.

The proximal end 64 of lance 50 may include rear support block 66 where tubes 52a-j extend to connect, via high pressure fittings, to a high pressure supply of cleaning fluid, e.g., water and video control equipment. Typically, lance 50 is several feet long and the tubes are brazed together every half foot, approximately.

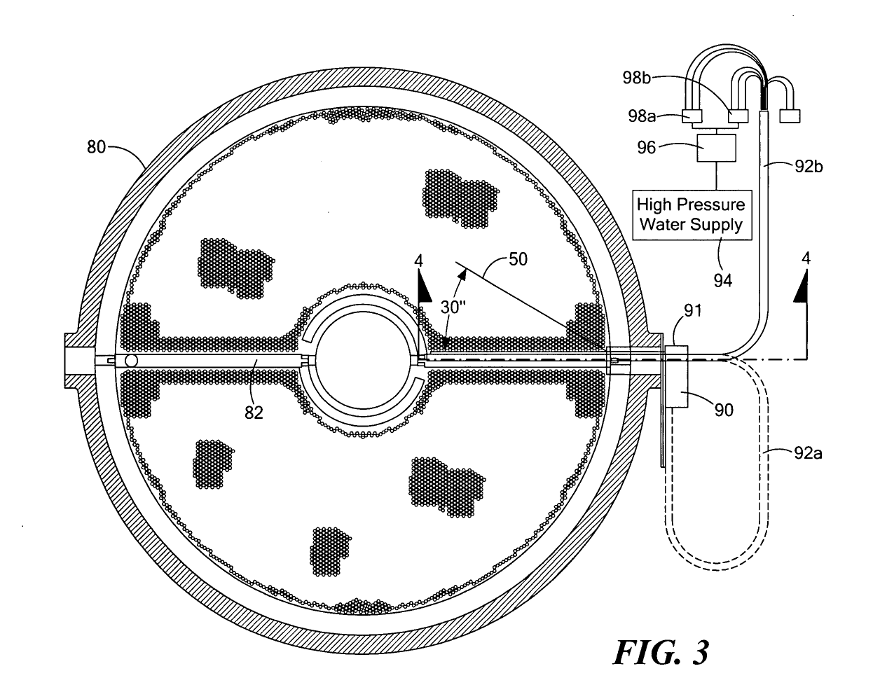

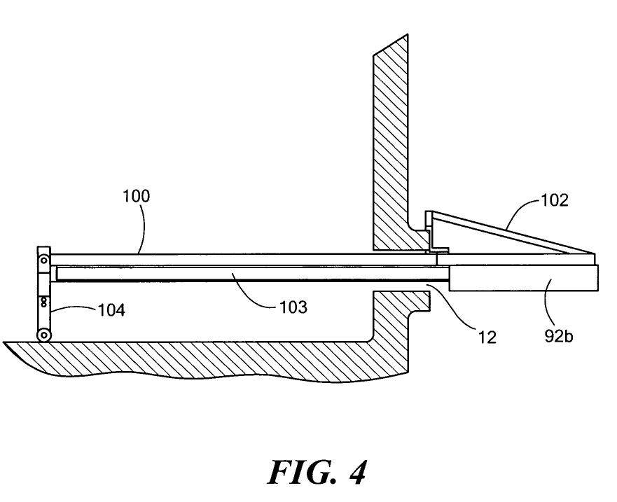

The subject invention also features, in one embodiment, a complete cleaning system including a lance drive and a mechanism configured to position the distal or head end of the lance in a no-tube lane of a steam generator at the entrance to a tube lane and for guiding the distal end of the lance into and along the tube lane for cleaning the tubes on either side of the tube lane. Lance drive 90, FIGS. 3-4, advances and retracts lance 50, parallel to the tube sheet, within particular tube lanes. Two alternate lance magazines 92a and 92b are shown. High pressure water supply 94 delivers water under pressure to manifold 96 and from there to manifolds 98a and 98b connected to tubes 52b-d and 52h-j, respectively.

FIG. 4 shows a rail subsystem including rail 100 and insert rail 103 positioned along the no-tube lane of the steam generator after being introduced through hand hole opening 12, lance magazine 92b, hand hole support 102, and rail kickstand 104.

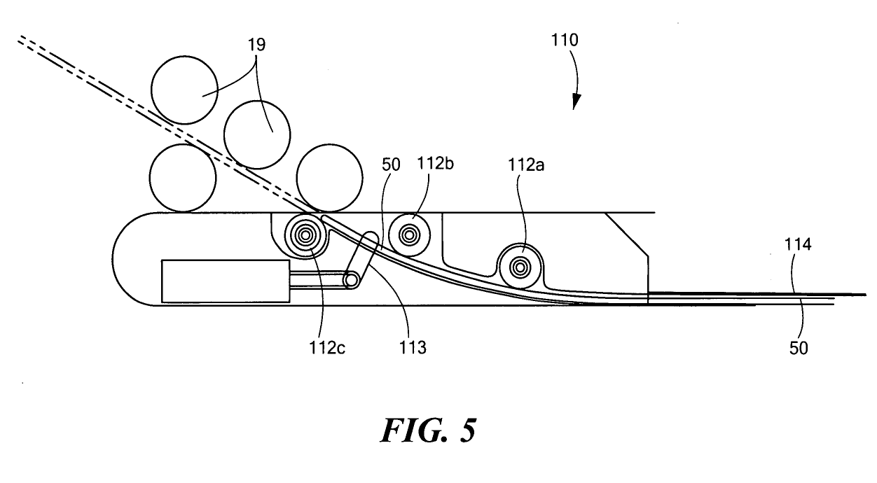

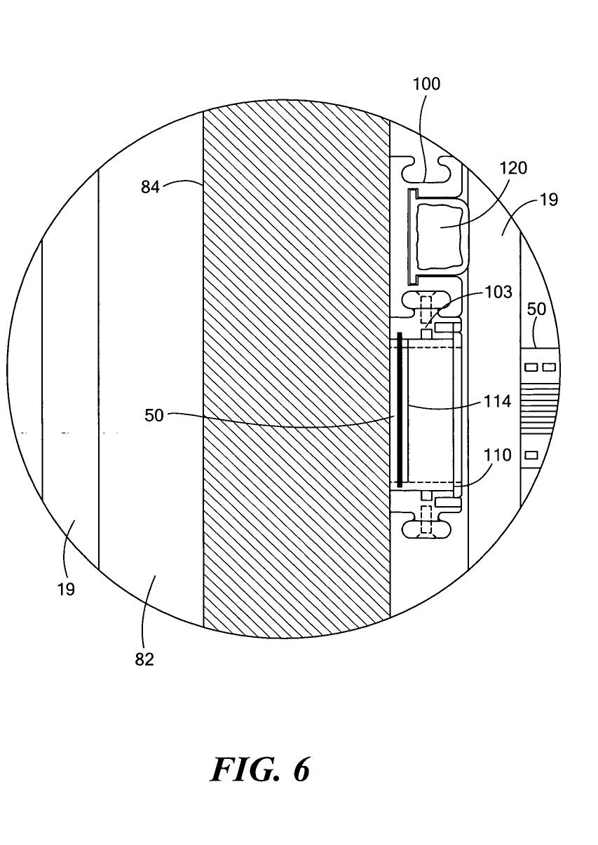

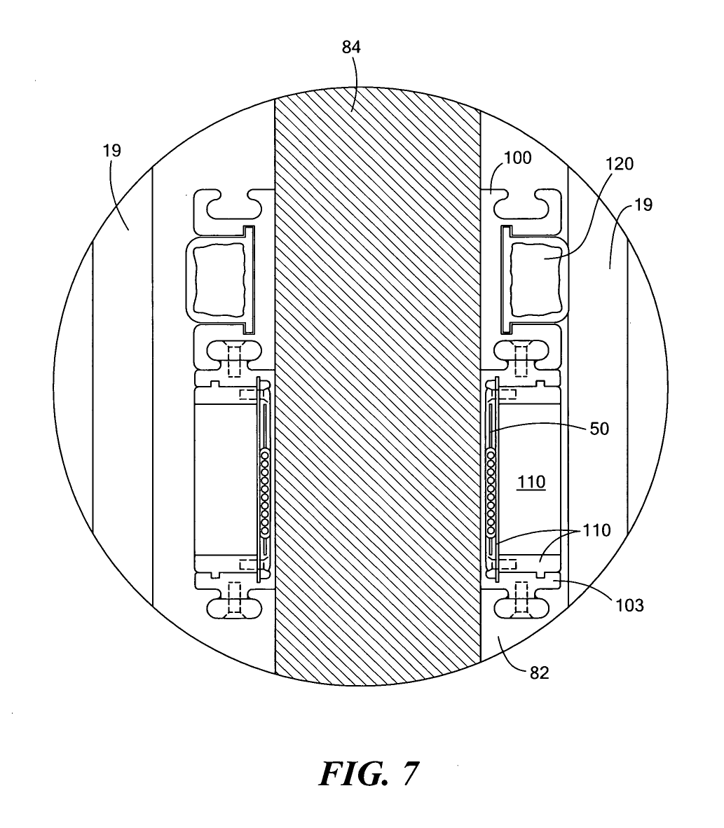

In one embodiment, sliding lance guide 110, FIG. 5 is received in the no-tube lane of the steam generator on one side of divider plate 84, FIGS. 6-7. Sliding lance guide 110, in this example, is the mechanism for positioning the head end of the lance in a no-tube lane of the steam generator at the entrance to a specific tube lane and for guiding the head end of the lance into the selected tube lane. After, the lance is retracted, the head of the lance is positioned at the entrance to another tube lane, and again the lance is advanced down the tube lane for cleaning tubes on either side thereof.

Rollers 112a-112c, FIG. 5 of sliding lance guide 110 are configured to reorient the lance at an angle for insertion into a chosen tube lane. Lance guide tape 114, FIGS. 5-7 extends from sliding lance guide 110 to the exterior of the steam generator through the hand hole. Sliding lance guide 110 slides on insert rail 103. Two such systems may be employed at the same time as shown in FIG. 7 on opposite sides of divider plate 84 for faster cleaning. The sliding lance guide rides in and out of the steam generator on grooves located on the insert rail. When the lance head is at the home position, inside the sliding lance guide, a pneumatically activated brake 113 engages the lance drive holes and holds the lance in place. Driving the lance with the brake engaged drives sliding lance guide 110 forward or reverse. To drive lance 50 in a steam generator tube lane, lance 50 is first aligned for entry using a fiber scope for guiding. Tape break 91, FIG. 3 is then engaged with tape 114 and pneumatic lance break 113, FIG. 5 is released to then drive the lance. Inflatable bladder 120, FIG. 7 biases rail 116 against divider plate 84 in the no-tube lane when the bladder is inflated between rail 116 and tubes adjacent the no-tube lane such as tube 19.

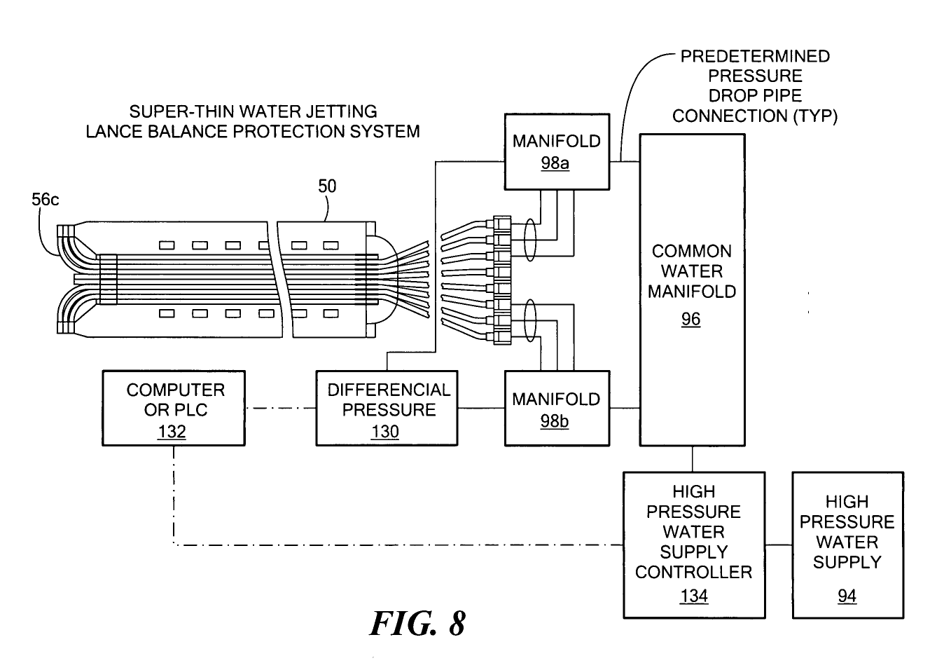

FIG. 8 shows high pressure cleaning fluid supply 94 connected to common manifold 96 itself connected to manifold 98a for the upwardly angled tubes of lance 50 and manifold 98b connected to the downwardly angled tubes of lance 50. Differential pressure sensor 130 serves as means for sensing a differential pressure between manifolds 98a and 98b to detect, for example, if one of the tubes is clogged. If upwardly angled tube 56c, for example, becomes clogged or otherwise inoperable, an imbalanced situation will occur which could cause potential damage to the lance system and the steam generator components. Differential pressure sensor 130 detects this situation since the clogging of lance tube 56c would increase the pressure in manifold 98a. Processing electronics 132 is responsive to differential pressure sensor 130 and is configured to stop the supply of cleaning fluid via high pressure water supply controller 134 if there is a differential pressure greater than a preset threshold between manifolds 98a and 98b.

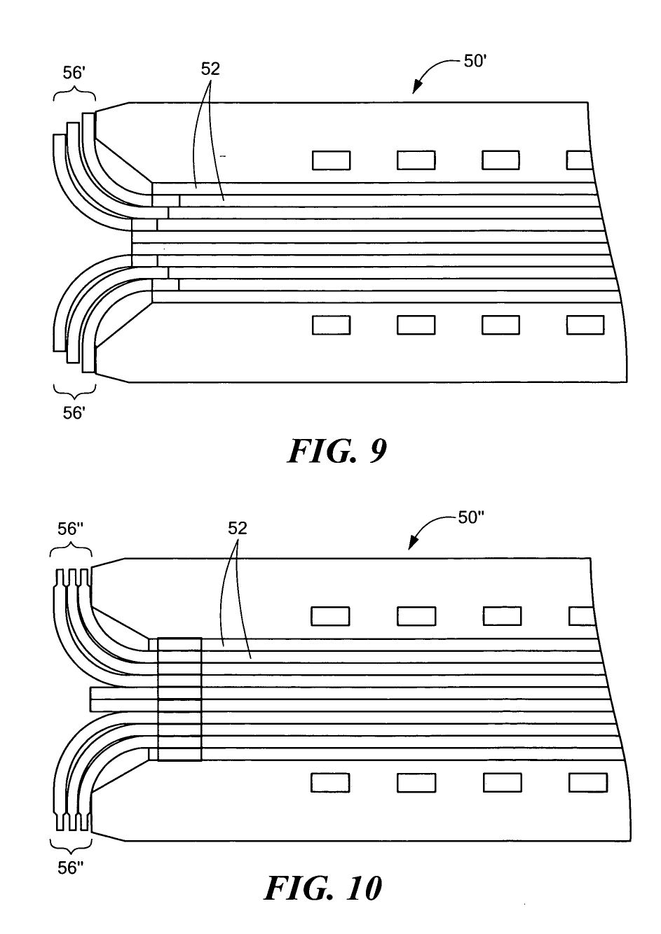

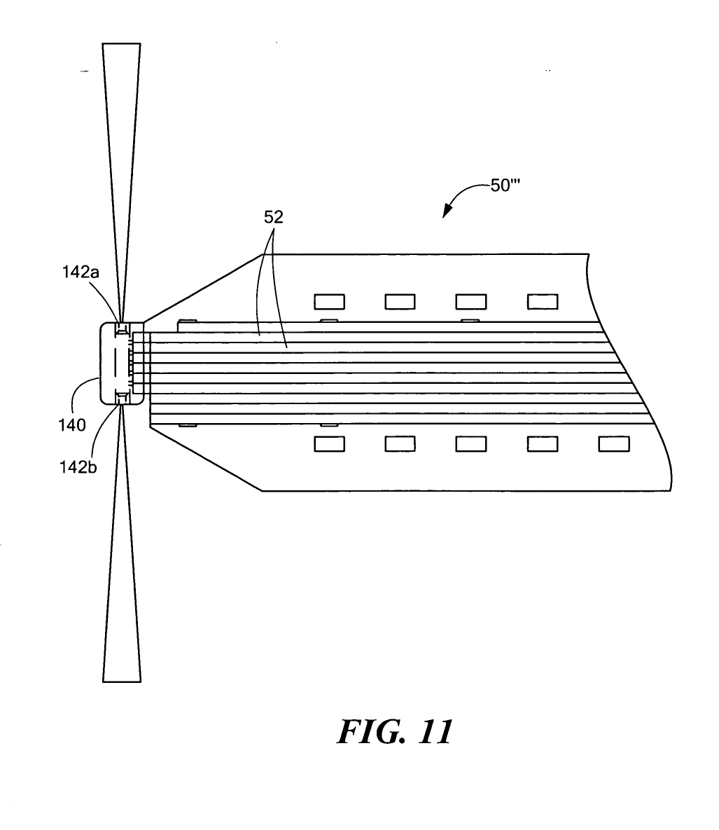

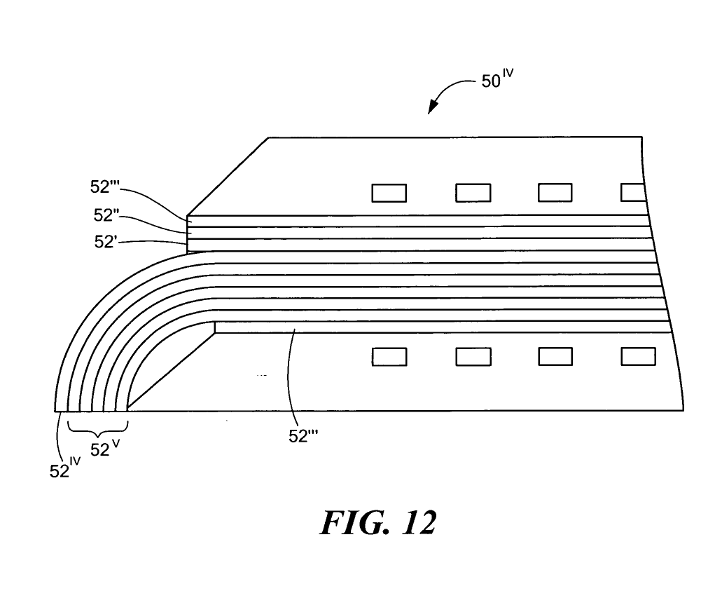

FIG. 9 shows lance 50′ with reduced diameter tubes 56′ attached to tubes 52 and serving as the nozzles. FIG. 10 shows tubes 52 including formed reduced diameter distal ends serving as the nozzles for lance 50″. In FIG. 11, lance 50′″includes lance head plenum 140 attached to tubes 52 and including opposing jet-nozzles 142a and 142b.

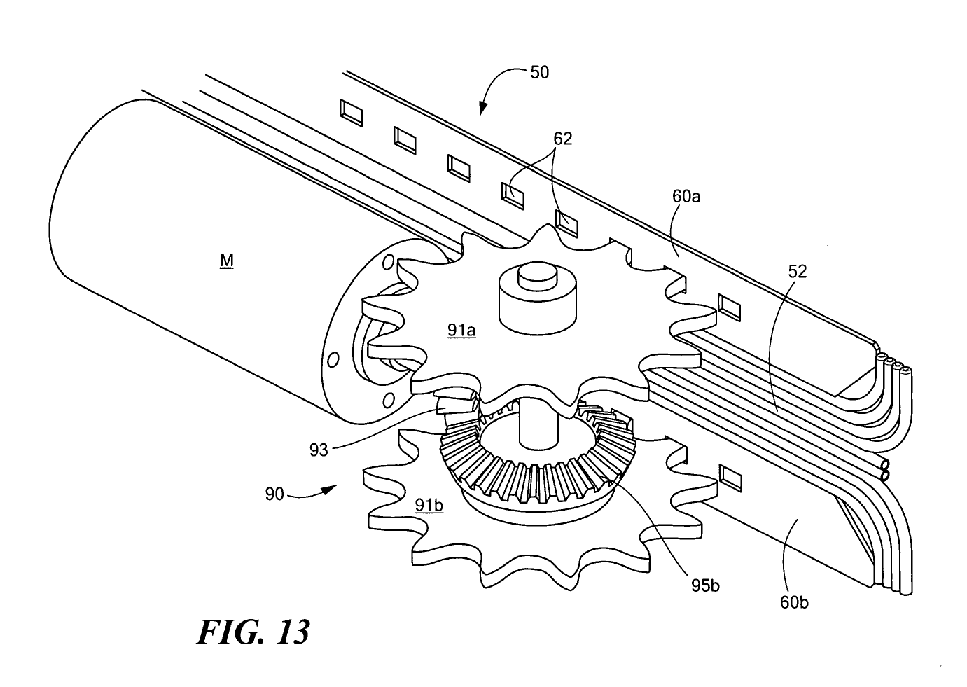

FIG. 12 shows inspection lance 50^{iv} with forward looking fiberscope tube 52′, air purge and light tube 52′, and buffer tube′″; used to align in a tube gap and fiberscope tube 52^{iv} and light pipes 52′ in a downwardly looking configuration for inspecting the tube sheet. The inspection lance is typically provided with the system including the cleaning lance and is driven the same way as the cleaning lance.

FIG. 13 shows lance drive 90 with upper sprocket 91a and lower sprocket 91b driven by motor M via gear 93 which drives gear 95b coupled to lower sprocket 91b and a similar gear, not shown, coupled to upper drive sprocket 91a. The sprockets, as shown, engage the spaced drive sprocket holes 62 in their respective drive strips 60a and 60b.

The super-thin water jetting lance of the subject invention, in any embodiment, thus addresses several deficiencies of existing systems. The lance includes a plurality of metallic flexible tubes, with or without any metallic drive strips attached to it, capable of being driven from outside the steam generator, (thus eliminating the need for large no-tube lane access space) along the no-tube lane, and entering the 30 degree tube lanes for inspection and sludge deposits removal. The advantage of this lance over any known technology is that it does not require an additional exoskeleton for structure and driving. The metal tubes provide adequate structure necessary for driving the lance into and out of a steam generator inter-tube gap, yet flexible enough to bend 30° for entry into tube lanes.

Driving of the super-thin water jetting lance can be done either by friction, or positive engagement. When a friction drive is employed, the lance tubes are squeezed between two rubber rollers driven by a motor. When a positive drive is used, a motor driven sprocket, engages sprocket holes 62, FIG. 2 on the metallic strips. Therefore, the lance can be much thinner than any of the existing technologies, by not using an exoskeleton. By using metallic flexible tubes to carry the pressurized water, the water pressure can be much higher than that of conventional lances therefore delivering much higher hydraulic power, making it very effective against any hard sludge deposits in the inter-tube areas of steam generators.

The result, in any embodiment, is a new cleaning and/or inspection lance with a configuration which is able to access steam generator inter-tube gaps that conventional and commercially available lances cannot access due to geometrical limitations. The cleaning/inspection lance system of the subject invention is reliable, easy to operate, and efficient. Hydraulic pressure is maximized for more effective cleaning.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A steam generator cleaning system comprising:
a cleaning lance comprising a stack of adjacent tubes in a single column, the tubes secured together at least some locations, the lance including a distal end with tube nozzles;
a mechanism for positioning the distal end of the lance in a no-tube lane of the steam generator at the entrance to a tube lane and for guiding the distal end of the lance into said tube lane; and
means for driving the lance so that the distal end thereof enters said tube lane.

2. The system of claim 1 in which the lance includes a thin drive strip on the top and bottom of the tube stack.

3. The system of claim 2 in which each drive strip includes spaced drive sprocket holes and the means for driving includes an upper sprocket and a lower sprocket and a motor for rotating the upper and lower sprockets.

4. The system of claim 2 in which the drive strip is made of a metal thinner than the diameter of the tubes.

5. The system of claim 1 in which the tubes are made of metal.

6. The system of claim 5 in which the tubes are brazed together at least some locations.

7. The system of claim 1 in which the mechanism includes a sliding lance guide received in a no-tube lane.

8. The system of claim 7 in which the sliding lance guide includes rollers configured to reorient the lance at an angle for insertion into a tube lane.

9. The system of claim 7 further including a rail subsystem received in the no-tube lane slidingly supporting the sliding lance guide.

10. The system of claim 9 further including an inflatable bladder biasing and fixing the rail subsystem against a steam divider plate in the no-tube lane.

11. The system of claim 9 in which the sliding lance guide includes a lance guide break operable to engage the lance so the means for driving, when operated with the break engaging the lance, drives the sliding lance guide and the means for driving, when operating with the break disengaged, drives the lance.

12. The system of claim 11 in which the sliding lance guide includes a lance guide tape extending therefrom and further including a tape break, which, when operated to engage the tape, and with the lance break disengaged from the lance, fixes the sliding lance guide in a particular position so that the means for driving operates to drive the lance into a tube lane.

13. The system of claim 1 in which the tube nozzles comprise reduced diameter tubes.

14. The system of claim 1 in which the tube nozzles comprise reduced diameter tube sections.

15. The system of claim 1 in which the tube nozzles comprise jet nozzles attached to the tubes.

16. The system of claim 1 in which the tube nozzles include a lance head plenum.

17. The system of claim 1 in which there are N tubes, M of which carry a cleaning fluid, M/2 of which are angled upwardly at the distal end of the lance, and M/2 of which are angled downwardly at the distal end of the lance.

18. The system of claim 17 in which M is less than N.

19. The system of claim 17 further including a high pressure cleaning fluid supply connected to a proximal end of the lance, a manifold for the upwardly angled tubes, and a manifold for the downwardly angled tubes.

20. The system of claim 19 further including means for sensing a differential pressure between both manifolds.

21. The system of claim 20 further including processing electronics responsive to the means for sensing a differential pressure and configured to stop the supply of cleaning fluid to the tubes if a differential pressure greater than a preset threshold exists in the manifolds to prevent potential damage to the lance and/or steam generator.

22. The system of claim 1 in which the outer diameter of each tube is less than 0.116 inches.

23. The system of claim 1 in which the width of the lance is less than 0.096 inches.

24. The system of claim 1 further including an inspection lance configured with tubes secured together at least some locations.

25. A steam generator cleaning system comprising:
a cleaning lance comprising a stack of adjacent tubes in a single column, the tubes secured together at least some locations, the lance including a distal end with tube nozzles, in which there are N tubes, M of which carry a cleaning fluid, M/2 are angled upwardly, and M/2 of which are angled downwardly at the distal end of the lance;
a mechanism for positioning the distal end of the lance in a no-tube lane of the steam generator at the entrance to a tube lane and for guiding the distal end of the lance into said tube lane;
means for driving the lance so that the distal end thereof enters said tube lane;
a high pressure cleaning fluid supply connected to a proximal end of the lance, a manifold for the upwardly angled tubes, and a manifold for the downwardly angled tubes;
means for sensing a differential pressure between both manifolds;
processing electronics responsive to the means for sensing a differential pressure and configured to stop the supply of cleaning fluid to the tubes if a differential pressure greater than a preset threshold exists in the manifolds to prevent potential damage to the lance and/or steam generator.

26. A steam generator cleaning system comprising:
a cleaning lance comprising a stack of adjacent tubes in a single column, the tubes secured together at least some locations, the lance including a distal end with tube nozzles, and a thin drive strip on both the top and bottom of the tube stack;
a mechanism for positioning the distal end of the lance in no-tube lane of the steam generator at the entrance to a tube lane and for guiding the distal end of the lance into said tube lane; and
means for driving the lance so the distal end thereof enters the tube lane.

27. A steam generator cleaning system comprising:
a cleaning lance comprising a stack of adjacent tubes in a single column, the tubes secured together at least some locations, the lance including a distal end with tube nozzles;
a sliding lance guide received in the no-tube lane including rollers configured to reorient the lance at an angle for insertion into a tube lane;
a rail subsystem received in the no-tube lane slidingly supporting the sliding lance guide thereon; and
means for driving the lance with respect to the sliding lance guide to proceed down a tube lane.

28. A small tube gap steam generator lance comprising:
a stack of adjacent metallic tubes in a single column, the tubes secured together at least some locations;
the tubes having a diameter less than the width of the tube lane; and
no lance structure wider than the tube lane.

29. A small tube gap steam generator tube lane lance comprising:
a stack of adjacent metallic tubes in a single column secured together at least some locations;
a thin drive strip on both the top and bottom of the tube stack;
the tubes having a diameter less than the width of the tube lane; and
no lance structure wider than the tube lane.

30. A steam generator cleaning and inspection system comprising:
a cleaning lance comprising a stack of adjacent tubes in a single column, the tubes secured together at least some locations, the lance including a distal end with tube nozzles;
an inspection lance configured with a single column of tubes secured together at least some locations;
a mechanism for positioning the distal end of each lance in a no-tube lane of the steam generator at the entrance to a tube lane and for guiding the distal end of each lance into said tube lane; and
means for driving each lance so that the distal end thereof enters said tube lane.
